(19) United States
(12) Patent Application Publication
(10) Pub. No.: US 2026/0213414 A1
(43) Pub. Date: Jul. 23, 2026

(54) ANTENNA SUBSTRATE, ANTENNA DEVICE, AND ELECTRONIC COMPONENT

(71) Applicant: TDK Corporation, Tokyo (JP)

(72) Inventor: Kenichi TEZUKA, Tokyo (JP)

(73) Assignee: TDK Corporation, Tokyo (JP)

(21) Appl. No.: 19/448,290

(22) Filed: Jan. 14, 2026

(30) Foreign Application Priority Data
Jan. 17, 2025 (JP) 2025-006724

(51) Int. Cl. H01Q 9/04; H01Q 1/22

(52) U.S. Cl. CPC H01Q 9/0414; H01Q 1/22

(57) ABSTRACT

An antenna substrate includes a substrate body including a first surface, a ground layer located on the first surface, and a radiation element located on the first surface on one side in a first direction and spaced from the ground layer. The ground layer includes a first portion and a second portion arranged in a second direction orthogonal to the first direction. The first portion includes a first outer edge portion that is a part of an outer edge of the first portion, is located on the one side in the first direction, and partially extends along the second direction. The second edge of the first outer edge portion is located on the one side in the second direction with respect to the first edge of the first outer edge portion and is located on the other side in the first direction with respect to the first edge.

### CROSS REFERENCE TO RELATED APPLICATIONS

This application claims the benefit of Japanese Priority Patent Application No. 2025-006724 filed on January 17, 2025, the entire contents of which are incorporated herein by reference.

### BACKGROUND

The disclosure relates to an antenna substrate, an antenna device, and an electronic component.

Examples of known wireless communication technologies include Ultra Wide Band (hereinafter, referred to as UWB). UWB provides wireless communications over a wide bandwidth of 500 MHz or more, for example.

Among known antennas suitable for UWB or wideband capable antennas is a monopole antenna including a plate-shaped radiation element, the radiation element including a portion that increases in width with increasing distance from a feed point and a ground plane. The portion that increases in width with increasing distance from the feed point and the ground plane serves to keep the input impedance of the radiation element substantially constant over a wide band.

JP 2019-208147A describes, as such a monopole antenna described above, an antenna device including a substrate body, a ground layer, a first radiation element, and an antenna element. The ground layer and the first radiation element are formed on the substrate body. The antenna element is mounted on the substrate body. The antenna element includes a second radiation element connected to the first radiation element.

Here, attention is paid to the arrangement of the radiation elements. In the course of the study by the inventors of the present application, it is found that a return loss (negative value) of a radiation element can be reduced when a corner of a ground layer exists near a radiation element. The corner of the ground layer is, for example, located near a corner of the substrate body. Therefore, disposing the radiation elements near the corner of the substrate body enables reduction of the return loss of the radiation elements and increase of radiation efficiency of the radiation elements. However, in some shapes of the substrate body, a configuration in which the radiation elements are located near the corner of the substrate body cannot be implemented in some cases.

### SUMMARY

An antenna substrate according to one embodiment of the disclosure includes a substrate body, a ground layer formed of a conductor and located on a surface of the substrate body, and a radiation element formed of a conductor and located on the surface of the substrate body and spaced from the ground layer on one side in a first direction. The ground layer includes a first portion and a second portion that are arranged in a second direction orthogonal to the first direction, the first portion and the second portion being separated by a boundary being a portion of the ground layer that has overlap with a virtual straight line passing through a center of the radiation element in the second direction and extending in the first direction. The first portion is located on one side in the second direction with respect to the boundary. The second portion is located on the other side in the second direction with respect to the boundary. The first portion includes an outer edge portion that is a part of an outer edge of the first portion, is located on the one side in the first direction, and partially extends along the second direction. The outer edge portion includes a first edge and a second edge. The second edge is located on the one side in the second direction with respect to the first edge and is located on the other side in the first direction with respect to the first edge.

An antenna device according to one embodiment of the disclosure includes the antenna substrate according to the disclosure, and a passive element mounted on the antenna substrate. The antenna substrate further includes a feed line. The passive element is electrically connected to the radiation element and the feed line.

An electronic component according to one embodiment of the disclosure includes the antenna substrate according to the disclosure, and an element including a ground terminal. The ground terminal is electrically connected to the ground layer.

Objects, features, and advantages of the disclosure will appear more fully from the following description.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is a plan view showing an antenna device according to a first example embodiment.

FIG. 2 is a plan view showing an antenna substrate according to the first example embodiment.

FIG. 3 is a plan view showing the antenna substrate according to the first example embodiment.

FIG. 4 is an enlarged plan view showing a part of the antenna substrate according to the first example embodiment.

FIG. 5 is a perspective view showing an antenna element and its surroundings in the antenna device according to the first example embodiment.

FIG. 6 is a plan view showing the antenna element and its surroundings in the antenna device according to the first example embodiment.

FIG. 7 is a perspective view showing the inside of the antenna element in the first example embodiment.

FIG. 8 is a plan view showing a line portion of the antenna element and its surroundings in the first example embodiment.

FIG. 9 is a plan view showing an antenna device of a comparative example.

FIG. 10 is a characteristic chart showing frequency characteristics of a return loss in a model of the comparative example.

FIG. 11 is a characteristic chart showing frequency characteristics of a return loss of a model of a first example.

FIG. 12 is a plan view showing an electronic component according to the first example embodiment.

FIG. 13 is a plan view showing an antenna substrate according to a second example embodiment.

FIG. 14 is a characteristic chart showing frequency characteristics of a return loss of a model of a second example.

FIG. 15 is a plan view showing an antenna substrate according to a third example embodiment.

FIG. 16 is a characteristic chart showing frequency characteristics of a return loss of a model of a third example.

### DETAILED DESCRIPTION

An object of the disclosure is to provide an antenna substrate, an antenna device, and an electronic component that are capable of reducing a return loss regardless of a position of a radiation element.

In the following, some example embodiments and modification examples of the disclosure will be described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions.

### First Example Embodiment

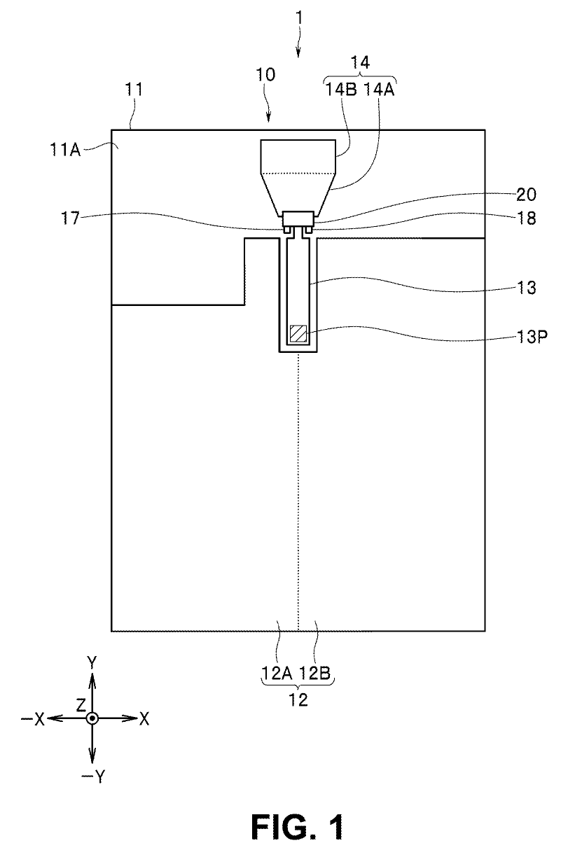

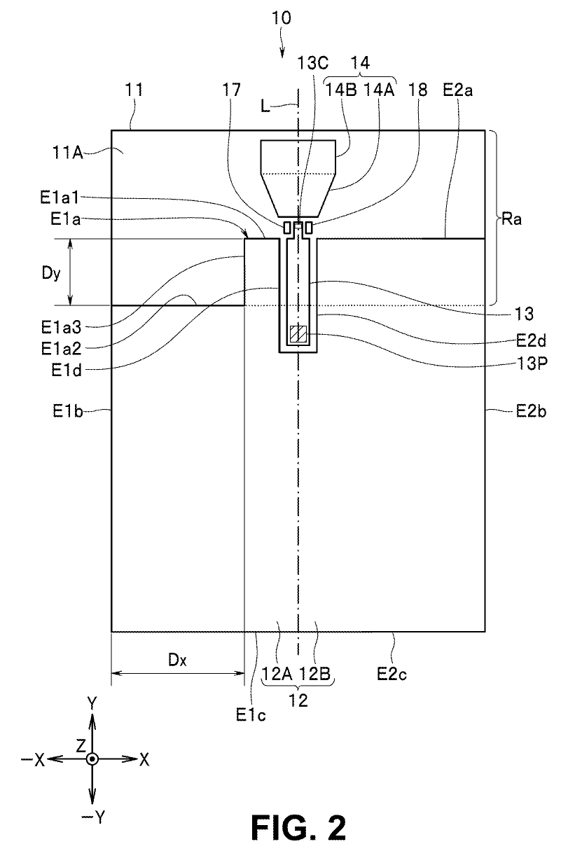

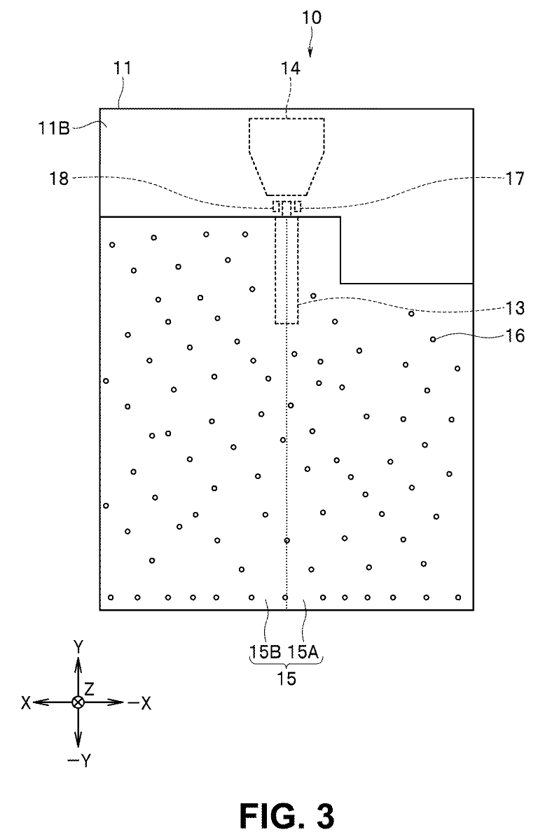

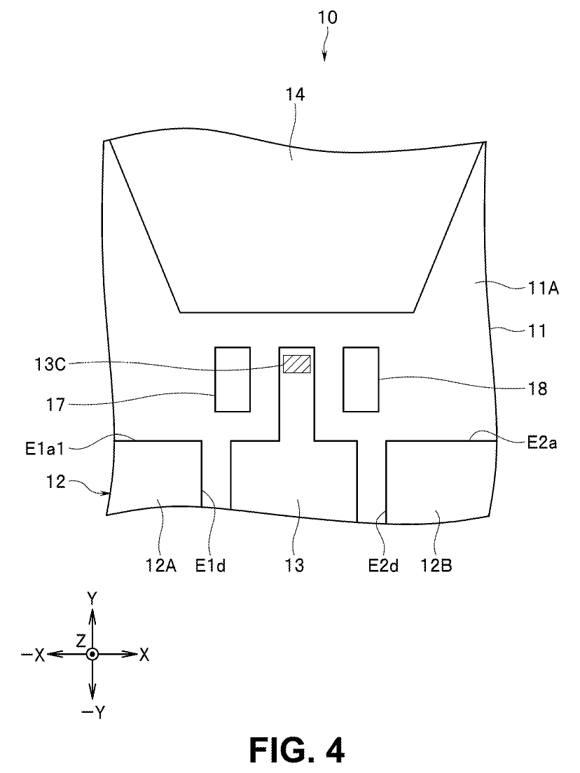

In the following, a first example embodiment of the disclosure is described in detail with reference to the accompanying drawings. First, an outline of a configuration of an antenna device according to an example embodiment is described with reference to FIG. 1 to FIG. 4. FIG. 1 is a plan view showing the antenna device according to the example embodiment. FIG. 2 is a plan view showing an antenna substrate according to the example embodiment. FIG. 3 is a plan view showing the antenna substrate according to the example embodiment. FIG. 4 is an enlarged plan view showing a part of the antenna substrate according to the example embodiment.

An antenna device 1 according to the example embodiment includes an antenna substrate 10 according to the example embodiment and a passive element 20. The passive element 20 is mounted on the antenna substrate 10. The passive element 20 is described in detail below.

As shown in FIG. 1 and FIG. 2, the antenna substrate 10 includes a substrate body 11. The substrate body 11 is formed of dielectric material. Examples of the dielectric material include resin, glass, ceramic, or a composite material. The composite material may contain one or more of resin, glass, and ceramic. The substrate body 11 has a first surface 11A and a second surface 11B opposite to each other. FIG. 2 shows the antenna substrate 10 as viewed from the first surface 11A side. FIG. 3 shows the antenna substrate 10 as viewed from the second surface 11B side.

Now, we define X, Y, and Z directions as illustrated in FIG. 1 to FIG. 4. The X, Y, and Z directions are orthogonal to one another. In the example embodiment, the Z direction is perpendicular to the first surface 11A of the substrate body 11, and toward the first surface 11A from the second surface 11B. The X and Y directions are both parallel to the first surface 11A. The opposite directions to the X, Y, and Z directions are defined as −X, −Y, and −Z directions, respectively.

As used herein, the term "above" refers to positions located forward of a certain reference position in the Z direction, and "below" refers to positions opposite to "above" with respect to the certain reference position. A direction parallel to the X direction and parallel to the −X direction is simply referred to as a "direction parallel to the X direction". A direction parallel to the Y direction and parallel to the −Y direction is simply referred to as a "direction parallel to the Y direction". A direction parallel to the Z direction and parallel to the −Z direction is simply referred to as a "direction parallel to the Z direction".

The direction parallel to the Y direction or the −Y direction corresponds to a "first direction" in the disclosure. The direction parallel to the X direction or the −X direction corresponds to a "second direction" in the disclosure. In the example embodiment, in particular, the Y direction corresponds to "one side in the first direction" in the disclosure, the −Y direction corresponds to "the other side in the first direction" in the disclosure, the −X direction corresponds to "one side in the second direction" in the disclosure, and the X direction corresponds to "the other side in the second direction" in the disclosure.

The antenna substrate 10 further includes a ground layer 12, a feed line 13, and a radiation element 14. The ground layer 12, the feed line 13, and the radiation element 14 are each formed of a conductor and located on the first surface 11A of the substrate body 11, which is a surface of the substrate body 11.

As illustrated in FIG. 1, FIG. 2, and FIG. 4, the feed line 13 is a transmission line having a predetermined length. The ground layer 12 is spaced from the feed line 13. The radiation element 14 is located on the Y direction side (one side in the first direction) and spaced from the ground layer 12 and the feed line 13.

In the example shown in FIG. 1 and FIG. 2, the feed line 13 extends in a direction parallel to the Y direction. The feed line 13 and the radiation element 14 are arranged in this order in the Y direction.

The feed line 13 includes a first connection 13C and a second connection 13P. The first connection 13C is located near an end portion of the feed line 13 closest to the radiation element 14. In the example shown in FIG. 1 and FIG. 2, the first connection 13C is located near the end portion of the feed line 13 in the Y direction.

The second connection 13P is located near an end portion of the feed line 13 farthest from the radiation element 14. In the example shown in FIG. 1 and FIG. 2, the second connection 13P is located near the end portion of the feed line 13 in the −Y direction. The second connection 13P corresponds to a feed point connected to the radiation element 14. The second connection 13P is connected to another feed line such as a cable or a wire that does not constitute the antenna substrate 10. Note that, in FIG. 1 and FIG. 2, the second connection 13P is hatched for the sake of convenience.

The radiation element 14 may include a width-changing portion 14A in which a dimension in the direction parallel to the X direction increases with increasing distance from the feed line 13. The planar shape of the width-changing portion 14A (the shape in plan view viewed from the Z direction) is, for example, a trapezoid. The radiation element 14 may further include a constant-width portion 14B connected to an end of the width-changing portion 14A in the Y direction. In FIG. 1 and FIG. 2, the boundary between the width-changing portion 14A and the constant-width portion 14B is shown by a dotted line. A dimension of the constant-width portion 14B in the direction parallel to the X direction is constant or substantially constant regardless of the position in the Y direction. Note that the configuration of the radiation element 14 is not limited to the example shown in FIG. 1 and FIG. 2. For example, the radiation element 14 may not include the constant-width portion 14B, and may be entirely the width-changing portion 14A. Alternatively, the radiation element 14 may not include the width-changing portion 14A, and may be entirely the constant-width portion 14B.

As shown in FIG. 1 to FIG. 3, the antenna substrate 10 further includes a ground layer 15, a plurality of through holes 16, and support portions 17 and 18. The ground layer 15 is formed of a conductor and is located on the second surface 11B. The plurality of through holes 16 penetrate the substrate body 11 and electrically connect the ground layer 12 and the ground layer 15. In FIG. 4, each circle represents a through hole 16.

The support portions 17 and 18 are formed of a conductor and located on the first surface 11A of the substrate body 11. The support portion 17 is spaced from the first connection 13C in the −X direction. The support portion 18 is spaced from the first connection 13C in the X direction. A portion of the feed line 13 sandwiched between the support portion 17 and the support portion 18 may have a smaller dimension in the direction parallel to the X direction than a dimension of a portion of the feed line 13 not sandwiched between the support portion 17 and the support portion 18.

Next, a configuration of the ground layer 12 is described in detail with reference to FIG. 1 and FIG. 2. The ground layer 12 includes a first portion 12A and a second portion 12B. The first portion 12A and the second portion 12B are arranged in a direction parallel to the X direction. In FIG. 1, the boundary between the first portion 12A and the second portion 12B is shown by a dotted line. The first portion 12A is located on the −X direction side (one side in the second direction) with respect to the above-described boundary. The second portion 12B is located on the X direction side (the other side in the second direction) with respect to the above-described boundary. In the example shown in FIG. 1, the above-described boundary extends in a direction parallel to the Y direction. In FIG. 2, a symbol L indicates a virtual straight line that intersects the above-described boundary and is parallel to the Y direction. The virtual straight line L passes through the center of the radiation element 14 in a direction (second direction) parallel to the X direction and extends in a direction (first direction) parallel to the Y direction. The above-described boundary, which is a part of the ground layer 12, has overlap with the virtual straight line L.

Each of the first portion 12A and the second portion 12B may have a rectangular planar shape as a whole. In the example embodiment, in particular, the first portion 12A and the second portion 12B are asymmetrical with respect to the virtual straight line L shown in FIG. 2. The planar shape of the first portion 12A is a shape deformed from a rectangle, and is a shape in which a notch having a shape along the feed line 13 is provided at a corner located at an end in the Y direction and an end in the X direction, and another notch is provided at a corner located at the end in the Y direction and an end in the −X direction. In the example embodiment, in particular, the shape of the other notch is rectangular or substantially rectangular.

The planar shape of the second portion 12B is a shape deformed from a rectangle, and is a shape in which a notch having a shape along the feed line 13 is provided at a corner located at an end in the Y direction and an end in the −X direction. The second portion 12B has a shape such that a part of the second portion 12B does not overlap the first portion 12A when the ground layer 12 or the antenna substrate 10 is folded along the virtual straight line L. The above-described part of the second portion 12B overlaps a region where the other notch is formed on the first portion 12A when the ground layer 12 or the antenna substrate 10 is folded along the virtual straight line L.

An outer edge of the first portion 12A (outer edge of the planar shape) includes a first outer edge portion E1a located on the Y direction side (one side in the first direction), a second outer edge portion E1b located on the −X direction side, a third outer edge portion E1c located on the −Y direction side, and a fourth outer edge portion E1d adjacent to the feed line 13 and spaced from the feed line 13.

A part of the first outer edge portion E1a extends along a direction (second direction) parallel to the X direction. The second outer edge portion E1b may extend along a direction parallel to the Y direction. The third outer edge portion E1c may extend along a direction parallel to the X direction. The second outer edge portion E1b and the third outer edge portion E1c may overlap the outer edge of the substrate body 11 in plan view viewed from the Z direction.

An outer edge of the second portion 12B (outer edge of the planar shape) includes a first outer edge portion E2a located on the Y direction side, a second outer edge portion E2b located on the X direction side, a third outer edge portion E2c located on the −Y direction side, and a fourth outer edge portion E2d adjacent to the feed line 13 and spaced from the feed line 13.

Each of the first outer edge portion E2a and the third outer edge portion E2c may extend along a direction parallel to the X direction. The second outer edge portion E2b may extend along a direction parallel to the Y direction. The second outer edge portion E2b and the third outer edge portion E2c may overlap the outer edge of the substrate body 11 in plan view viewed from the Z direction.

One end of the third outer edge portion E1c and one end of the third outer edge portion E2c are connected to each other at the boundary between the first portion 12A and the second portion 12B. One end of the fourth outer edge portion E1d and one end of the fourth outer edge portion E2d are connected to each other at the boundary between the first portion 12A and the second portion 12B. The feed line 13 is located between the fourth outer edge portion E1d and the fourth outer edge portion E2d. The fourth outer edge portions E1d and E2d have a shape along the feed line 13.

Next, the first outer edge portion E1a of the first portion 12A is described in detail with reference to FIG. 1 and FIG. 2. A part of the first outer edge portion E1a has a shape along the other notch described above, specifically, the notch located at the end in the −X direction and the end in the Y direction in the planar shape of the first portion 12A. In the example embodiment, in particular, the notch is a step-shaped notch.

The first portion 12A includes a first edge E1a1 and a second edge E1a2 which are parts of the first outer edge portion E1a, and a third edge E1a3 which is another part of the first outer edge portion E1a and connects the first edge E1a1 and the second edge E1a2. The second edge E1a2 is located on the −X direction side (one side in the second direction) with respect to the first edge E1a1 and is located on the −Y direction side (the other side in the first direction) with respect to the first edge E1a1.

The first edge E1a1 extends along a direction parallel to the X direction. One end of the first edge E1a1, specifically, an end portion located at an end of the first edge E1a1 in the X direction is connected to the fourth outer edge portion E1d. In a direction parallel to the Y direction, the first edge E1a1 may be arranged at the same or substantially the same position as the first outer edge portion E2a of the outer edge of the second portion 12B.

The second edge E1a2 extends along a direction parallel to the X direction. Note that, as long as the second edge E1a2 extends in a direction parallel to the X direction as a whole, at least a part of the second edge E1a2 may extend in a direction inclined with respect to the direction parallel to the X direction. One end of the second edge E1a2, specifically, an end portion of the second edge E1a2 located at the end in the −X direction is connected to the second outer edge portion E1b.

One end of the second edge E1a2 may be located at the outer edge of the substrate body 11. In other words, one end of the second edge E1a2 may overlap the outer edge of the substrate body 11 in plan view viewed from the Z direction.

The third edge E1a3 is connected to the other end of the first edge E1a1, specifically, an end portion of the first edge E1a1 located at the end in the −X direction, and the other end of the second edge E1a2, specifically, an end portion of the second edge E1a2 located at the end in the X direction. The third edge E1a3 extends along a direction (first direction) parallel to the Y direction. Note that, as long as the third edge E1a3 extends in a direction parallel to the Y direction as a whole, at least a part of the third edge E1a3 may extend in a direction inclined with respect to the direction parallel to the Y direction.

A portion other than the one end of the second edge E1a2 and the first and third edges E1a1 and E1a3 are located at positions not overlapping the outer edge of the substrate body 11 in plan view viewed from the Z direction.

In the example embodiment, the one end of the second edge E1a2 coincides with an end portion of the first outer edge portion E1a, the end portion being located at an end of the first outer edge portion E1a in the −X direction. Here, the other end of the first edge E1a1 is referred to as a first end portion of the first edge E1a1, and the above-described end portion of the first outer edge portion E1a is referred to as a second end portion of the first outer edge portion E1a. The first end portion of the first edge E1a1 is located at the end of the first edge E1a1 in the −X direction. In FIG. 2, a symbol Dx indicates a distance between the first end portion of the first edge E1a1 and the second end portion of the first outer edge portion E1a in a direction (second direction) parallel to the X direction. The symbol Dy indicates a distance between the first edge E1a1 and the second edge E1a2 in a direction (first direction) parallel to the Y direction. The distance Dy may be smaller than the distance Dx.

The distance Dy may be smaller or larger than a dimension of the feed line 13 in a direction parallel to the Y direction. In the former case, the second edge E1a2 may be located between the first edge E1a1 and the second connection 13P in the direction parallel to the Y direction.

In FIG. 2, a symbol Ra indicates a region on the surface of the substrate body 11 on the Y direction side of the second edge E1a2. An area of the first portion 12A in the region Ra is smaller than an area of the second portion 12B in the region Ra.

Next, the ground layer 15 is described with reference to FIG. 3. The ground layer 15 includes a first portion 15A and a second portion 15B. The first portion 15A and the second portion 15B are arranged in a direction parallel to the X direction. In FIG. 3, the boundary between the first portion 15A and the second portion 15B is shown by a dotted line. The first portion 15A is located on the −X direction side with respect to the above-described boundary. The second portion 15B is located on the X direction side of the above-described boundary.

The planar shape of the first portion 15A is the same or substantially the same as the planar shape of the first portion 12A of the ground layer 12 except for a portion near the feed line 13. The planar shape of the second portion 15B is the same or substantially the same as the planar shape of the second portion 12B of the ground layer 12 except for a portion near the feed line 13. A part of each of the first portion 15A and the second portion 15B may overlap the feed line 13 in plan view viewed from the Z direction.

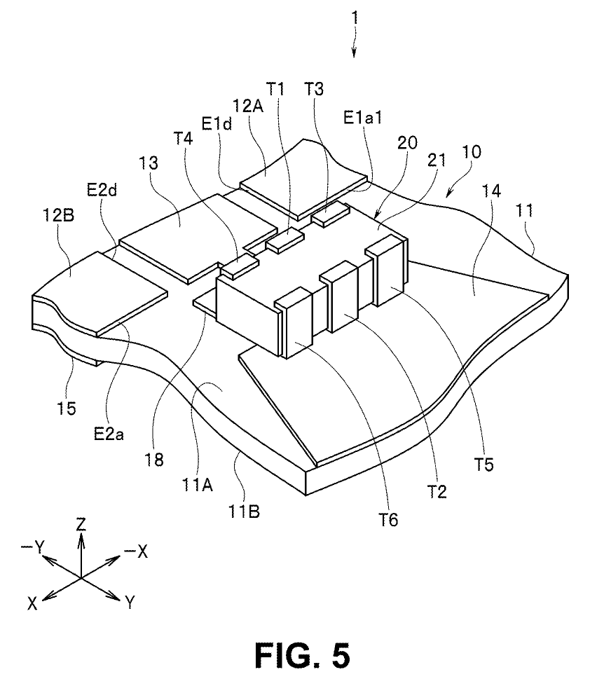

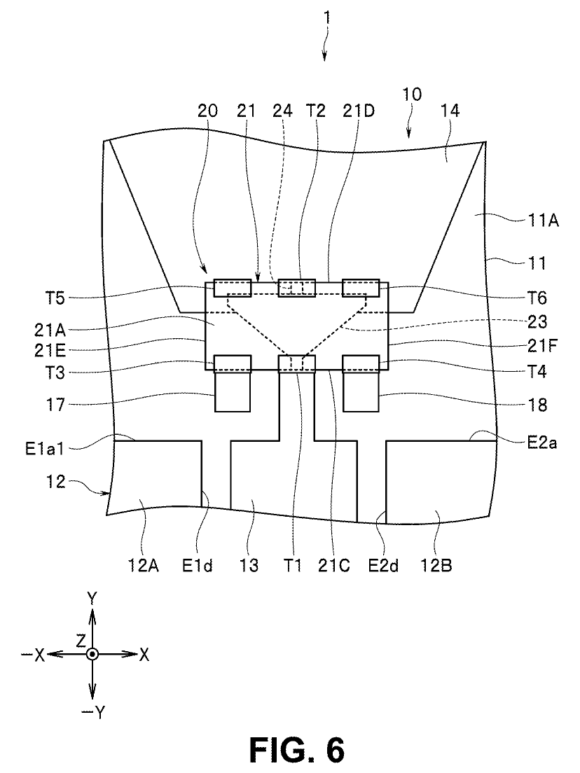

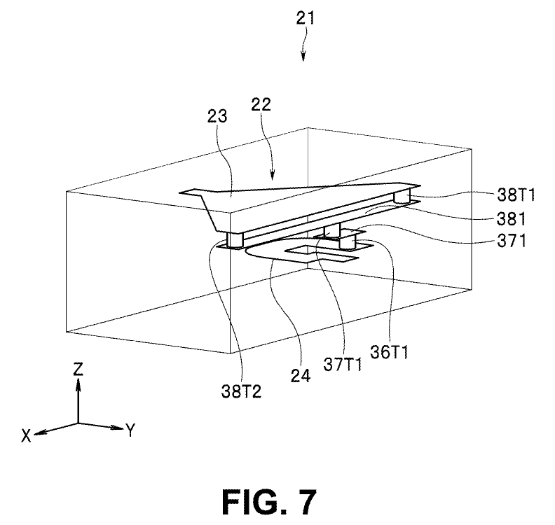

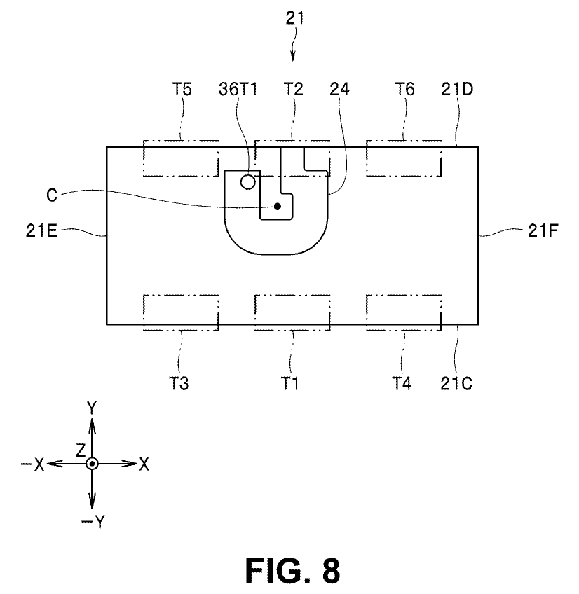

Next, other configurations of the antenna device 1 are described with reference to FIG. 5 to FIG. 8. FIG. 5 is a perspective view showing the passive element 20 and its surroundings. FIG. 6 is a plan view showing the passive element 20 and its surroundings. FIG. 7 is a perspective view showing the interior of the passive element 20. FIG. 8 is a plan view showing a line portion 24 of the passive element 20 and its surroundings. The passive element 20 may be an antenna element provided with a radiation element, a circuit element provided with at least one of an inductor and a capacitor, or a composite element provided with at least one of an inductor and a capacitor in addition to a radiation element. Hereinafter, a case where the passive element 20 is an antenna element is described as an example.

The passive element 20 includes an element body 21 and an outer surface. The element body 21 is formed of a stack including a plurality of dielectric layers being stacked and a plurality of conductors (a plurality of conductor layers and a plurality of through holes). Each of the plurality of dielectric layers may be made of a dielectric material having a relative permittivity higher than that of the dielectric material forming the substrate body 11. Examples of the dielectric material of the element body 21 include ceramic.

For example, the element body 21 has a rectangular parallelepiped shape, as shown in FIG. 5. In this case, the outer surface of the element body 21 includes a top surface 21A, a bottom surface, and four side surfaces 21C, 21D, 21E, and 21F. The top surface 21A is located at an end of the element body 21 in the Z direction. The bottom surface is located at an end of the element body 21 in the −Z direction. The bottom surface is a facing surface configured to face the antenna substrate 10. The side surface 21C is located at an end of the element body 21 in the −Y direction. The side surface 21D is located at an end of the element body 21 in the Y direction. The side surface 21E is located at an end of the element body 21 in the −X direction. The side surface 21F is located at an end of the element body 21 in the X direction.

The passive element 20 further includes terminals T1, T2, T3, T4, T5, and T6 located on the outer surface of the element body 21. The terminals T1, T3, and T4 are located to extend from the top surface 21A to the bottom surface via the side surface 21C. The terminal T3 is located on the −X direction side with respect to the terminal T1. The terminal T4 is located on the X direction side with respect to the terminal T1. The terminals T2, T5, and T6 are located to extend from the top surface 21A to the bottom surface via the side surface 21D. The terminal T5 is located on the −X direction side with respect to the terminal T2. The terminal T6 is located on the X direction side with respect to the terminal T2.

As illustrated in FIG. 6, the passive element 20 is mounted on the antenna substrate 10 such that the terminal T1 is connected to the feed line 13 and the terminal T2 is connected to the radiation element 14. In a state where the passive element 20 is mounted on the antenna substrate 10, the terminal T1 is connected to the first connection 13C, the terminal T3 is connected to the support portion 17, the terminal T4 is connected to the support portion 18, and the terminals T5 and T6 are connected to the radiation element 14.

As shown in FIG. 7, the passive element 20 further includes a radiation element 22 formed of a conductor and provided in the element body 21. The radiation element 22 electrically connects the terminal T1 and the terminal T2. The radiation element 22 includes a main conductor layer 23, a line portion 24, connection conductor layers 371 and 381, and through holes 36T1, 37T1, 38T1 and 38T2.

The main conductor layer 23 includes an end portion located on the side surface 21C and in contact with the terminal T1. The main conductor layer 23 includes a width-changing portion in which a dimension in a direction parallel to the X direction increases with increasing distance from the terminal T1. The planar shape of the width-changing portion is, for example, a trapezoid. An end of the main conductor layer 23 in the Y direction spaced from the side surface 21D and faces the side surface 21D.

As shown in FIG. 7 and FIG. 8, the line portion 24 is formed of one conductor layer located below the main conductor layer 23. The line portion 24 includes a first end portion located on the side surface 21D and in contact with the terminal T2, and a second end portion located on the opposite side of the first end portion. The line portion 24 is shaped to extend about the axis C that extends in the Z direction.

The connection conductor layers 371 and 381 are located near the side surface 21D. The connection conductor layer 371 is located between the main conductor layer 23 and the line portion 24 in a direction parallel to the Z direction. The connection conductor layer 381 is located between the main conductor layer 23 and the connection conductor layer 371 in the direction parallel to the Z direction.

The through hole 36T1 connects a portion of the line portion 24 near the second end portion to the connection conductor layer 371. The through hole 37T1 connects the connection conductor layer 371 to the connection conductor layer 381. The through holes 38T1 and 38T2 are spaced from each other in a direction parallel to the X direction, and connect the connection conductor layer 381 and the main conductor layer 23.

The terminal T1 is electrically connected to the terminal T2 via the main conductor layer 23, the through holes 38T1 and 38T2, the connection conductor layer 381, the through hole 37T1, the connection conductor layer 371, the through hole 36T1, and the line portion 24.

No conductor in the element body 21 is connected to the terminal T3, T4, T5, or T6.

Next, the operation and effects of the antenna substrate 10 according to the example embodiment are described. In the example embodiment, the first outer edge portion E1a of the first portion 12A of the ground layer 12 includes the first edge E1a1 and the second edge E1a2. The second edge E1a2 is located on the −X direction side with respect to the first edge E1a1 and is located on the −Y direction side with respect to the first edge E1a1. With this, according to the example embodiment, the return loss may be reduced regardless of the positions of the radiation elements 14 and 22. Hereinafter, such effect is described with reference to simulation results.

The simulation uses a model of a comparative example and a model of a first example. The model of the comparative example is a model of an antenna device of the comparative example. The model of the first example is a model of the antenna device 1 according to the example embodiment.

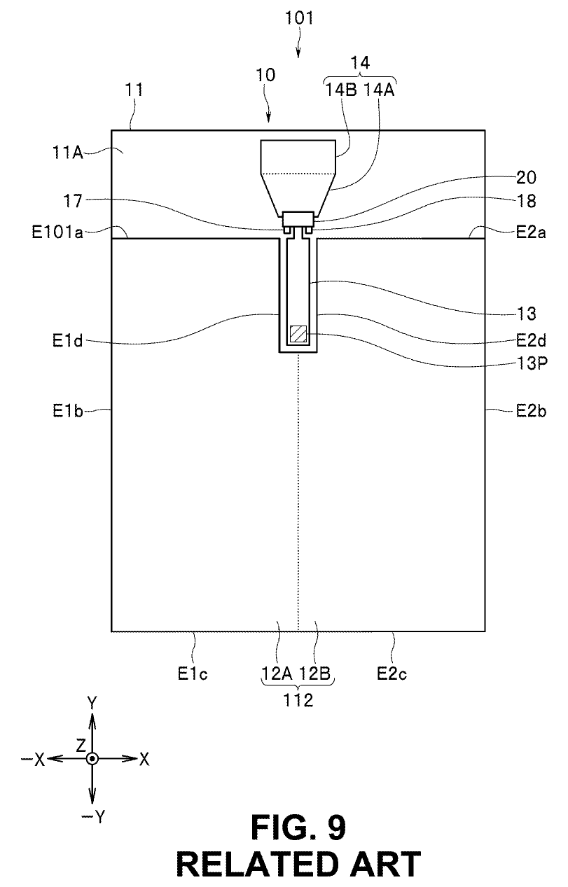

Here, a configuration of an antenna device 101 of the comparative example is described with reference to FIG. 9. FIG. 9 is a plan view showing the antenna device 101 of the comparative example. The antenna device 101 of the comparative example includes a ground layer 112 of the comparative example instead of the ground layer 12 of the example embodiment. The configuration of the ground layer 112 of the comparative example is basically the same as the configuration of the ground layer 12. Specifically, the ground layer 112 of the comparative example includes the first portion 12A and the second portion 12B, similarly to the ground layer 12. However, in the comparative example, the outer edge of the first portion 12A includes an outer edge portion E101a instead of the first outer edge portion E1a in the example embodiment.

The outer edge portion E101a extends in a direction parallel to the X direction as a whole. The outer edge portion E101a connects the second outer edge portion E1b and the fourth outer edge portion E1d. The outer edge portion E101a substantially corresponds to an edge obtained by extending the first edge E1a1 to the second outer edge portion E1b in the example embodiment. The other configurations of the antenna device of the comparative example are the same as those of the antenna device 1.

In the simulation, in each of the model of the comparative example and the model of the first example, a dimension of the substrate body 11 in a direction parallel to the Y direction is 48 mm, and a dimension of the substrate body 11 in a direction parallel to the X direction is 23 mm. In the simulation, in the model of the first example, the distance Dx between the first end portion of the first edge E1a1 and the second end portion of the first outer edge portion E1a in a direction parallel to the X direction is 10 mm, and the distance Dy between the first edge E1a1 and the second edge E1a2 in a direction parallel to the Y direction is 8 mm.

In the simulation, the model of the comparative example and the model of the first example are designed such that a bandwidth BW of each of the antenna device 101 in the model of the comparative example and the antenna device 1 in the model of the first example is from 6.2 GHz to 8.3 GHz. Then, the frequency characteristics of the return loss of the radiation elements 14 and 22 are obtained for each of the model of the comparative example and the model of the first example.

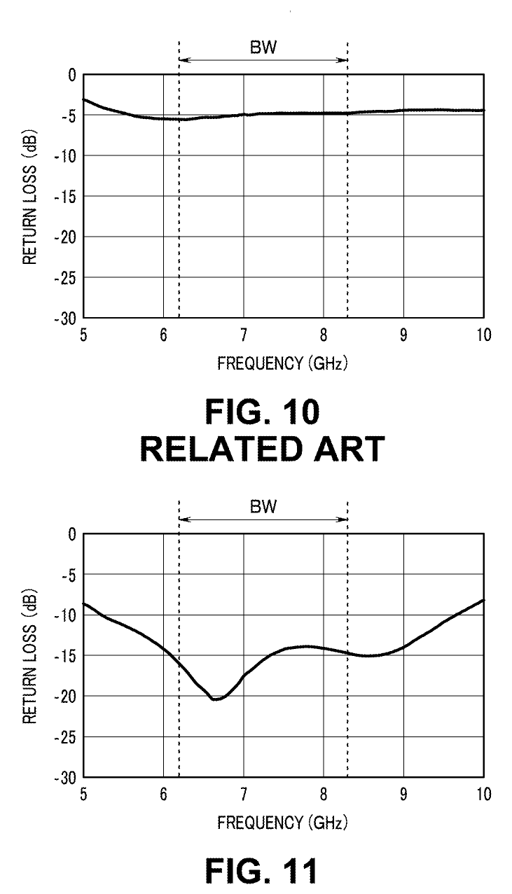

FIG. 10 is a characteristic chart showing the frequency characteristics of the return loss in the model of the comparative example. FIG. 11 is a characteristic chart showing the frequency characteristics of the return loss of the model of the first example. In FIG. 10 and FIG. 11, the horizontal axis represents frequency, and the vertical axis represents return loss. In FIG. 10 and FIG. 11, a frequency region sandwiched between two straight broken lines indicates a bandwidth BW. It is understood from FIG. 10 and FIG. 11 that the return loss of the model of the first example is smaller than that of the model of the comparative example.

In the course of the study by the inventors of the present application, it was found that a return loss can be reduced when a corner of the ground layer 12 (112) is located near the radiation elements 14 and 22. The corner of the ground layer 12 (112) is located near the corner of the substrate body 11, for example. Therefore, when the radiation elements 14 and 22 are located near the corner of the substrate body 11, the return loss can be reduced. On the other hand, in the comparative example, the radiation elements 14 and 22 are provided not near the corner of the substrate body 11 but near the center of the substrate body 11 in a direction parallel to the X direction. Therefore, in the comparative example, the return loss cannot be reduced.

In contrast, according to the example embodiment, the first edge E1a1 and the second edge E1a2 can substantially provide the corner of the ground layer 12 near the radiation elements 14 and 22. In other words, according to the example embodiment, it is possible to substantially implement a configuration in which the radiation elements 14 and 22 are located near the corner of the ground layer 12 regardless of the positions of the radiation elements 14 and 22. With this, according to the example embodiment, the return loss may be reduced regardless of the positions of the radiation elements 14 and 22.

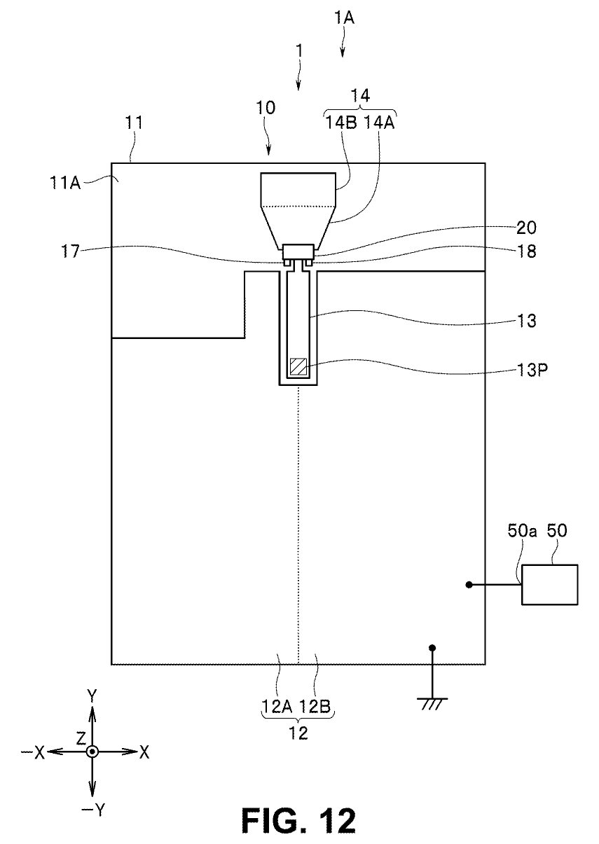

Next, an electronic component 1A according to an example embodiment is described with reference to FIG. 12. FIG. 12 is a plan view showing the electronic component 1A. The electronic component 1A includes the antenna device 1 and an element 50. As described above, the antenna device 1 includes the antenna substrate 10, and thus it can be said that the electronic component 1A includes the antenna substrate 10 and the element 50.

The element 50 may be any active element such as a transistor or a semiconductor IC, or may be any passive element such as an inductor or a capacitor. The element 50 may constitute a part of any circuit. The number of elements 50 is not limited to one, and may be plural.

The element 50 includes a ground terminal 50a. The ground terminal 50a is electrically connected to the ground layer 12. The ground terminal 50a may be connected to the ground layer 12 at a position away from the radiation elements 14 and 22. Note that in the example shown in FIG. 12, the ground terminal 50a is connected to the second portion 12B of the ground layer 12. On the other hand, the ground terminals 50a may be connected to the first portion 12A of the ground layer 12. The element 50 may further include another terminal electrically connected to the second connection 13P of the feed line 13.

In the electronic component 1A, the ground layer 12 can be used as a ground layer of the element 50. With this, according to the example embodiment, the electronic component 1A can be reduced in size as compared with a case where a ground layer for the element 50 is provided separately from the ground layer 12.

### Second Example Embodiment

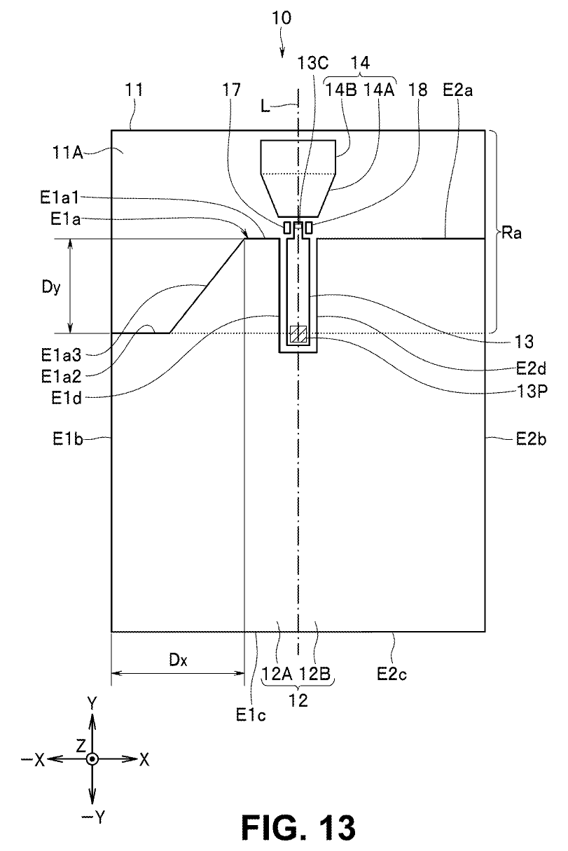

Next, a second example embodiment of the disclosure is described. First, with reference to FIG. 13, a description is given of a difference in the configuration of the antenna substrate 10 according to the example embodiment from that of the first example embodiment. FIG. 13 is a plan view showing a configuration of the antenna substrate 10 according to the example embodiment.

In the example embodiment, the shape of the first outer edge portion E1a of the first portion 12A of the ground layer 12 is different from that of the first example embodiment. Specifically, in the example embodiment, the third edge E1a3 of the first outer edge portion E1a extends along a direction inclined with respect to each of a direction parallel to the X direction and a direction parallel to the Y direction. A distance between the third edge E1a3 and the fourth outer edge portion E1d in the direction parallel to the X direction decreases as a distance to the radiation elements 14 decreases.

The planar shape of the first portion 12A is a shape deformed from a rectangle, and is a shape in which a notch having a shape along the feed line 13 is provided at a corner located at an end in the Y direction and an end in the X direction, and another notch is provided at a corner located at the end in the Y direction and an end in the −X direction. In the example embodiment, in particular, the shape of the other notch is a trapezoid.

The other configurations of the antenna substrate 10 according to the example embodiment are the same as those of the first example embodiment.

Next, an example of characteristics of the antenna device according to the example embodiment obtained by simulation is described. The antenna device according to the example embodiment includes the antenna substrate 10 according to the example embodiment, and the passive element 20 (antenna element) described in the first example embodiment, which includes the radiation element 22 provided in the element body 21. Although not shown, the passive element 20 is mounted on the antenna substrate 10 according to the example embodiment, similarly to the first example embodiment.

The simulation uses a model of a second example. The model of the second example is a model of an antenna device according to the example embodiment. In the simulation, a dimension of the substrate body 11 in a direction parallel to the Y direction is 48 mm, and a dimension of the substrate body 11 in a direction parallel to the X direction is 23 mm. In the simulation, the distance Dx between the first end portion of the first edge E1a1 and the second end portion of the first outer edge portion E1a in a direction parallel to the X direction is 10 mm. The distance Dy between the first edge E1a1 and the second edge E1a2 in a direction parallel to the Y direction is 8 mm. A dimension of the second edge E1a2 in the direction parallel to the X direction is 4.8 mm.

In the simulation, the model of the second example is designed such that a bandwidth BW of the antenna device in the model of the second example is from 6.2 GHz to 8.3 GHz. Then, the frequency characteristics of the return loss of the radiation elements 14 and 22 are obtained.

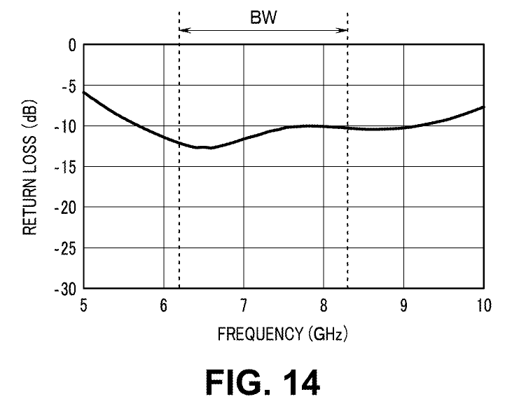

FIG. 14 is a characteristic chart showing frequency characteristics of a return loss of the model of the second example. In FIG. 14, the horizontal axis represents frequency, and the vertical axis represents return loss. In FIG. 14, a frequency region sandwiched between two straight broken lines indicates a bandwidth BW. From FIG. 14, it is understood that the antenna device according to the example embodiment has practically sufficient characteristics as an antenna device.

The other configurations, operation, and effects of the example embodiment are similar to those of the first example embodiment.

### Third Example Embodiment

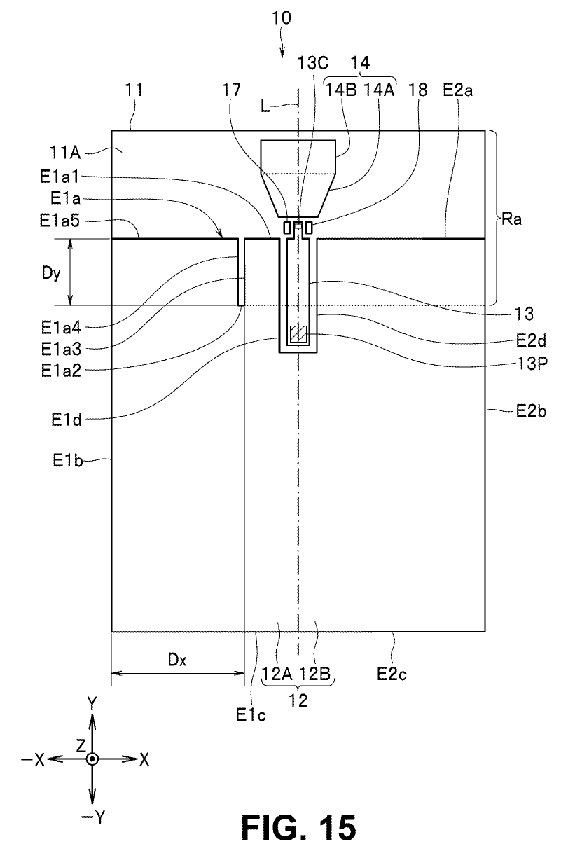

Next, a third example embodiment of the disclosure is described. First, with reference to FIG. 15, a description is given of a difference in the configuration of the antenna substrate 10 according to the example embodiment from that of the first example embodiment. FIG. 15 is a plan view showing a configuration of the antenna substrate 10 according to the example embodiment.

In the example embodiment, the planar shape of the first portion 12A of the ground layer 12 is different from that of the first example embodiment. Specifically, in the example embodiment, the planar shape of the first portion 12A is a shape deformed from a rectangle, and is a shape in which a notch having a shape along the feed line 13 is provided at a corner located at an end in the Y direction and an end in the X direction, and a slit extending in a direction parallel to the Y direction from an end portion located at an end of the rectangle in the Y direction is provided. Note that, as long as the slit extends in the direction parallel to the Y direction as a whole, at least a part of the slit may extend in a direction inclined with respect to the direction parallel to the Y direction.

In the example embodiment, the shape of the first outer edge portion E1a is different from that of the first example embodiment. Specifically, in the example embodiment, a dimension of the second edge E1a2 of the first outer edge portion E1a is different from that of the first example embodiment. One end of the second edge E1a2 is not connected to the second outer edge portion E1b.

The first outer edge portion E1a includes a fourth edge E1a4 and a fifth edge E1a5 in addition to the first to third edges E1a1, E1a2, and E1a3. One end of the fourth edge E1a4 is connected to one end of the second edge E1a2. One end of the fifth edge E1a5 is connected to the other end of the fourth edge E1a4. The other end of the fifth edge E1a5 is connected to the second outer edge portion E1b.

The fourth edge E1a4 extends along a direction parallel to the Y direction. The length of the fourth edge E1a4 is the same or substantially the same as the length of the third edge E1a3. Note that, as long as each of the third edge E1a3 and the fourth edge E1a4 extends in a direction parallel to the Y direction as a whole, at least a part of the third edge E1a3 or the fourth edge E1a4 may extend in a direction inclined with respect to the direction parallel to the Y direction.

The fifth edge E1a5 extends along a direction parallel to the X direction. The position of the fifth edge E1a5 in the direction parallel to the Y direction is the same or substantially the same as the position of the first edge E1a1 in the direction parallel to the Y direction. The other end of the fifth edge E1a5 may be located at an outer edge of the substrate body 11. In other words, the other end of the fifth edge E1a5 may overlap the outer edge of the substrate body 11 in plan view viewed from the Z direction. Note that, as long as the fifth edge E1a5 extends in the direction parallel to the X direction as a whole, at least a part of the fifth edge E1a5 may extend in a direction inclined with respect to the direction parallel to the X direction.

The other configurations of the antenna substrate 10 according to the example embodiment are the same as those of the first example embodiment.

Next, an example of characteristics of the antenna device according to the example embodiment obtained by simulation is described. The antenna device according to the example embodiment includes the antenna substrate 10 according to the example embodiment and the passive element 20 described in the first example embodiment. Although not shown, the passive element 20 is mounted on the antenna substrate 10 according to the example embodiment, similarly to the first example embodiment.

The simulation uses a model of a third example. The model of the third example is a model of an antenna device according to the example embodiment. In the simulation, a dimension of the substrate body 11 in a direction parallel to the Y direction is 48 mm, and a dimension of the substrate body 11 in a direction parallel to the X direction is 23 mm. In the simulation, the distance Dx between the first end portion of the first edge E1a1 and the second end portion of the first outer edge portion E1a in a direction parallel to the X direction is 9 mm. The distance Dy between the first edge E1a1 and the second edge E1a2 in a direction parallel to the Y direction is 6 mm. A dimension of the second edge E1a2 in the direction parallel to the X direction is 0.5 mm.

In the simulation, the model of the third example is designed such that a bandwidth BW of the antenna device in the model of the third example is from 6.2 GHz to 8.3 GHz. Then, the frequency characteristics of the return loss of the radiation elements 14 and 22 are obtained.

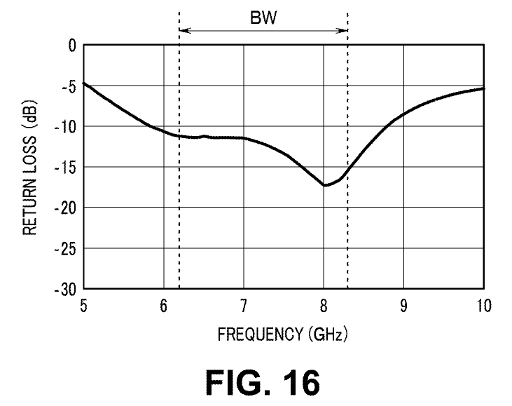

FIG. 16 is a characteristic chart showing frequency characteristics of a return loss of a model of a third example. In FIG. 16, the horizontal axis represents frequency, and the vertical axis represents return loss. In FIG. 16, a frequency region sandwiched between two straight broken lines indicates a bandwidth BW. From FIG. 16, it is understood that the antenna device according to the example embodiment has practically sufficient characteristics as an antenna device.

The other configurations, operation, and effects of the example embodiment are similar to those of the first example embodiment.

Note that the disclosure is not limited to the foregoing example embodiments, and various modifications may be made thereto. For example, as long as the requirements of the claims are satisfied, the planar shape of the first portion 12A of the ground layer 12 is not limited to the examples illustrated in the example embodiments, and may be any shape. The shape of each edge is not limited to a straight line, and may be a shape including a curve.

As described above, the antenna substrate according to one embodiment of the disclosure includes a substrate body, a ground layer formed of a conductor and located on a surface of the substrate body, and a radiation element formed of a conductor and located on the surface of the substrate body and spaced from the ground layer on one side in a first direction. The ground layer includes a first portion and a second portion that are arranged in a second direction orthogonal to the first direction, the first portion and the second portion being separated by a boundary being a portion of the ground layer that has overlap with a virtual straight line passing through a center of the radiation element in the second direction and extending in the first direction. The first portion is located on one side in the second direction with respect to the boundary. The second portion is located on the other side in the second direction with respect to the boundary. The first portion includes an outer edge portion that is a part of an outer edge of the first portion, is located on the one side in the first direction, and partially extends along the second direction. The outer edge portion includes a first edge and a second edge. The second edge is located on the one side in the second direction with respect to the first edge and is located on the other side in the first direction with respect to the first edge. Therefore, the return loss can be reduced regardless of the position of the radiation element.

In the antenna substrate according to one embodiment of the disclosure, one end of the second edge may be located at an outer edge of the substrate body. In this case, the return loss can be further reduced.

In the antenna substrate according to one embodiment of the disclosure, the first edge may include a first end portion located at an end of the first edge on the one side in the second direction. The outer edge portion may include a second end portion located at an end of the outer edge portion on the one side in the second direction. A distance between the first edge and the second edge in the first direction may be smaller than a distance between the first end portion and the second end portion in the second direction. In this case, the area of the ground layer can be secured while reducing the return loss, and thus the region that can be used as the ground layer of an element mounted on the antenna substrate can be enlarged.

In the antenna substrate according to one embodiment of the disclosure, the first portion may further include a third edge connecting the first edge and the second edge. The third edge may extend along the first direction. The third edge may be located on the one side in the second direction with respect to the radiation element. In this case, the return loss can be further reduced, and a region that can be used as the ground layer of an element mounted on the antenna substrate can be secured.

In the antenna substrate according to one embodiment of the disclosure, the first portion and the second portion may be asymmetric with respect to the virtual straight line. In this case, the area of the ground layer can be secured while reducing the return loss, and thus the region that can be used as the ground layer of an element mounted on the antenna substrate can be enlarged.

In the antenna substrate according to one embodiment of the disclosure, an area of the first portion in a region on the surface of the substrate body on the one side in the first direction from the second edge may be smaller than an area of the second portion in the region. In this case, the area of the ground layer can be secured while reducing the return loss, and thus the region that can be used as the ground layer of an element mounted on the antenna substrate can be enlarged.

In the antenna substrate according to one embodiment of the disclosure, the second portion may have a shape such that a part of the second portion does not overlap the first portion when the ground layer or the antenna substrate is folded along the virtual straight line. In this case, the area of the ground layer can be secured while reducing the return loss, and thus the region that can be used as the ground layer of an element mounted on the antenna substrate can be enlarged.

The antenna substrate according to one embodiment of the disclosure may further include a feed point electrically connected to the radiation element. The second edge may be located between the first edge and the feed point in the first direction. In this case, the area of the ground layer can be secured while reducing the return loss, and thus the region that can be used as the ground layer of an element mounted on the antenna substrate can be enlarged.

An antenna device according to one embodiment of the disclosure includes the antenna substrate according to one embodiment of the disclosure, and a passive element mounted on the antenna substrate. The antenna substrate further includes a feed line. The passive element is electrically connected to the radiation element and the feed line. Therefore, the antenna device with a reduced return loss can be implemented.

An electronic component according to one embodiment of the disclosure includes the antenna substrate according to one embodiment of the disclosure, and an element including a ground terminal. The ground terminal is electrically connected to the ground layer. Therefore, the ground layer of the antenna substrate can be used as the ground layer of an element.

According to an aspect of the disclosure, it is possible to implement an antenna substrate, an antenna device, and an electronic component that are capable of reducing a return loss regardless of a position of a radiation element.

It is apparent that the disclosure can be carried out in various forms and modifications in the light of the foregoing descriptions. Accordingly, within the scope of the following claims and equivalents thereof, the disclosure can be carried out in forms other than the foregoing example embodiments.

1. An antenna substrate comprising:
a substrate body;
a ground layer formed of a conductor and located on a surface of the substrate body; and
a radiation element formed of a conductor and located on the surface of the substrate body and spaced from the ground layer on one side in a first direction, wherein
the ground layer includes a first portion and a second portion that are arranged in a second direction orthogonal to the first direction, the first portion and the second portion being separated by a boundary being a portion of the ground layer that has overlap with a virtual straight line passing through a center of the radiation element in the second direction and extending in the first direction,
the first portion is located on one side in the second direction with respect to the boundary,
the second portion is located on the other side in the second direction with respect to the boundary,
the first portion includes an outer edge portion that is a part of an outer edge of the first portion, is located on the one side in the first direction, and partially extends along the second direction,
the outer edge portion includes a first edge and a second edge, and
the second edge is located on the one side in the second direction with respect to the first edge and is located on the other side in the first direction with respect to the first edge.

2. The antenna substrate according to claim 1, wherein one end of the second edge is located at an outer edge of the substrate body.

3. The antenna substrate according to claim 1, wherein
the first edge includes a first end portion located at an end of the first edge on the one side in the second direction,
the outer edge portion includes a second end portion located at an end of the outer edge portion on the one side in the second direction, and
a distance between the first edge and the second edge in the first direction is smaller than a distance between the first end portion and the second end portion in the second direction.

4. The antenna substrate according to claim 1, wherein the first portion further includes a third edge connecting the first edge and the second edge.

5. The antenna substrate according to claim 4, wherein the third edge extends along the first direction.

6. The antenna substrate according to claim 4, wherein the third edge is located on the one side in the second direction with respect to the radiation element.

7. The antenna substrate according to claim 1, wherein the first portion and the second portion are asymmetric with respect to the virtual straight line.

8. The antenna substrate according to claim 1, wherein an area of the first portion in a region on the surface of the substrate body on the one side in the first direction from the second edge is smaller than an area of the second portion in the region.

9. The antenna substrate according to claim 1, wherein the second portion has a shape such that a part of the second portion does not overlap the first portion when the ground layer or the antenna substrate is folded along the virtual straight line.

10. The antenna substrate according to claim 1, further comprising
a feed point electrically connected to the radiation element, wherein
the second edge is located between the first edge and the feed point in the first direction.

11. An antenna device comprising:
the antenna substrate according to claim 1; and
a passive element mounted on the antenna substrate, wherein
the antenna substrate further includes a feed line, and
the passive element is electrically connected to the radiation element and the feed line.

12. An electronic component comprising:
the antenna substrate according to claim 1; and
an element including a ground terminal, wherein
the ground terminal is electrically connected to the ground layer.
